(19) United States
(12) Patent Application Publication
(10) Pub. No.: US 2016/0380274 A1
(43) Pub. Date: Dec. 29, 2016

(54) CATHODE AND METAL-AIR BATTERY USING THE SAME

(71) Applicants: Tsinghua University, Beijing (CN); HON HAI PRECISION INDUSTRY CO., LTD., New Taipei (TW)

(72) Inventors: YANG WU, Beijing (CN); SHUN-CHAO MA, Beijing (CN); ZHANG-QUAN PENG, Beijing (CN); JIA-PING WANG, Beijing (CN); KAI-LI JIANG, Beijing (CN); SHOU-SHAN FAN, Beijing (CN)

(21) Appl. No.: 14/838,423

(22) Filed: Aug. 28, 2015

(30) Foreign Application Priority Data
Jun. 25, 2015 (CN) 201510356571.3

(51) Int. Cl. H01M 4/90; H01M 12/08; H01M 4/92

(52) U.S. Cl. CPC H01M 4/9083; H01M 4/926; H01M 12/08; H01M 2004/8689

(57) ABSTRACT

A cathode of a metal-air battery includes a carbon nanotube network structure and a catalyst of particles located in the carbon nanotube network structure. The carbon nanotube network structure includes carbon nanotube films stacked with each other. Each of the carbon nanotube films includes carbon nanotubes aligned substantially parallel to a surface of the carbon nanotube film. A metal-air battery is also disclosed.

### CROSS-REFERENCE TO RELATED APPLICATIONS

This application claims all benefits accruing under 35 U.S.C. §119 from China Patent Application No. 201510356571.3, filed on Jun. 25, 2015, in the China Intellectual Property Office. This application is related to a commonly-assigned application entitled, “CATHODE AND LITHIUM-AIR BATTERY USING THE SAME”, filed ______ (Atty. Docket No. US58745).

### FIELD

The present disclosure relates to cathodes and metal-air batteries using the same, and particularly to cathodes and metal-air batteries based on carbon nanotubes.

### BACKGROUND

A metal-air battery is a chargeable/dischargeable battery that utilizes metal or metal compound in an active material of an anode electrode and oxygen gas as an active material in a cathode electrode. Oxygen gas, as the cathode electrode active material, can be obtained from air, and hence the cathode electrode active material need not be sealed in the battery. Therefore, metal-air battery realizes a capacity that is greater than that of secondary battery that utilizes solid cathode electrode active materials. By using different metals in the anode, the metal-air battery can be lithium-air battery, magnesium-air battery, zinc-air battery, aluminum-air battery, and so on.

During electrical discharging, the anode forms metal ions and electrons, wherein the metal ions transfer though the electrolyte and combine with the oxygen gas and the electrons at the cathode to produce a solid metal oxide. During electrical charging, the solid metal oxide decomposes to form the metal ions, oxygen gas, and electrons, wherein the metal ions go through the electrolyte and combine with the electrons at the anode to produce the metal. The reaction at the cathode can be expressed as 2M⁺+O₂+2e⁻⇄M₂O₂. The reaction at the anode complies with M⇄M⁺+e⁻. The cathode comprises a porous carbon material as a conducting carrier and a catalyst carried by the porous carbon material. During the discharging, the insoluble metal oxide is formed at the cathode in the pores of the porous carbon material and blocks the passage of the oxygen gas and the metal ions, which decreases the redox reaction speed and the power density of the metal-air battery.

### BRIEF DESCRIPTION OF THE DRAWINGS

Implementations of the present technology will now be described, by way of example only, with reference to the attached figures.

FIG. 1 is a schematic view of an embodiment of a cathode of a metal-air battery.

FIG. 2 is a scanning electron microscope (SEM) image of a carbon nanotube film.

FIG. 3 is a schematic view of another embodiment of the cathode of the metal-air battery.

FIG. 4 is a schematic view of yet another embodiment of the cathode of the metal-air battery.

FIG. 5 is a photograph of a carbon nanotube paper.

FIG. 6 is a schematic view of an embodiment of the metal-air battery.

FIG. 7 is a transmission electron microscopy (TEM) image of the cathode containing ruthenium (Ru) catalyst of the metal-air battery.

FIG. 8 is an SEM image of the cathode containing Ru catalyst of the metal-air battery after being discharged.

FIG. 9 is a discharge curve of the metal-air battery using the cathode of FIG. 7 and FIG. 8.

FIG. 10 is a TEM image of the cathode containing palladium (Pd) catalyst of the metal-air battery.

FIG. 11 is an SEM image of the cathode containing Pd catalyst of the metal-air battery after being discharged.

FIG. 12 is a discharge curve of the metal-air battery using the cathode of FIG. 10 and FIG. 11.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprise” or “comprising” when utilized, means “include or including, but not necessarily limited to”; it specifically indicates open-ended inclusion or membership in the so-described combination, group, series, and the like. The term “contact” when utilized, means “direct contact” or “physical contact.”

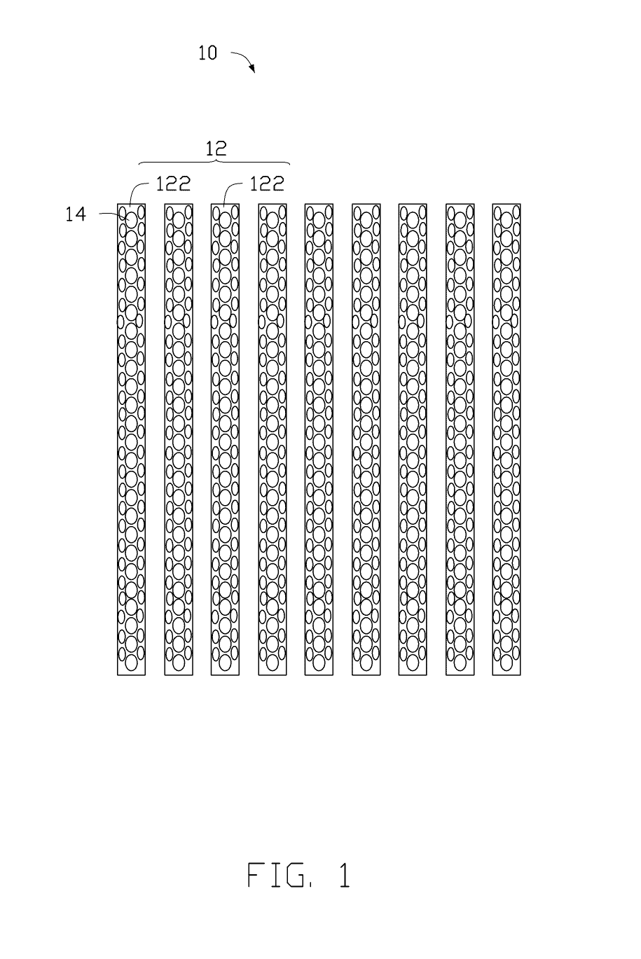

Referring to FIG. 1, one embodiment of a cathode 10 of a metal-air battery is shown. The cathode 10 comprises a carbon nanotube network structure 12 and a catalyst 14 in particle form located on walls of carbon nanotubes of the carbon nanotube network structure 12. The carbon nanotube network structure 12 comprises a plurality of carbon nanotube films 122 made of carbon nanotubes, and stacked with each other.

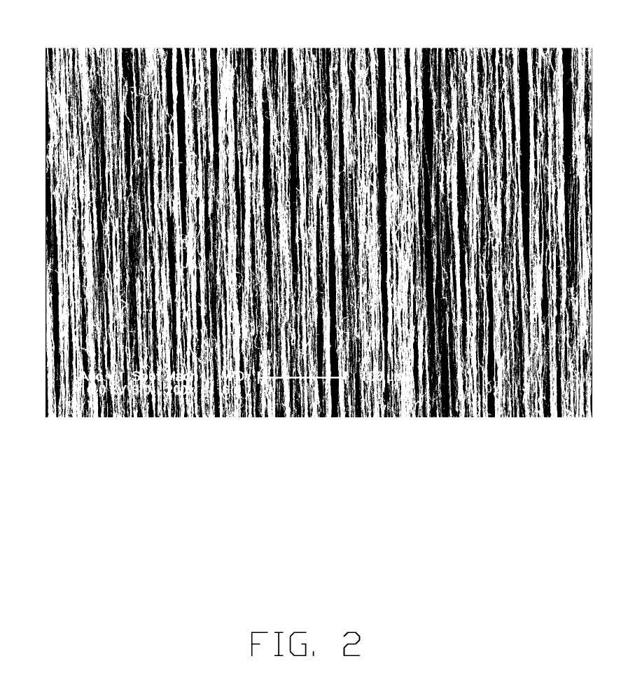

Referring to FIG. 2, the carbon nanotube film 122 comprises or consists of a plurality of carbon nanotubes. In the carbon nanotube film 122, the overall aligned direction of a majority of the carbon nanotubes is substantially parallel to a surface of the carbon nanotube film 122. A majority of the carbon nanotubes are substantially along the same direction in the carbon nanotube film 122. Along the aligned direction of the majority of carbon nanotubes, each carbon nanotube is joined to adjacent carbon nanotubes end to end by van der Waals attractive force therebetween, whereby the carbon nanotube film 122 is capable of being a free-standing structure. There may be a minority of randomly-aligned carbon nanotubes in the carbon nanotube film 122. However, the number of the randomly aligned carbon nanotubes is very small and does not affect the overall alignment of the majority of carbon nanotubes in the carbon nanotube film 122. Some of the majority of the carbon nanotubes in the carbon nanotube film 122 that are substantially aligned along the same direction may not be exactly straight, and can be curved to a certain degree, or not exactly in alignment to a certain degree. Therefore, partial contacts can exist between the juxtaposed carbon nanotubes in the majority of the carbon nanotubes aligned along the same direction in the carbon nanotube film 122. The carbon nanotube film 122 can comprise a plurality of successive carbon nanotube segments. Each of the plurality of carbon nanotube segments is joined end to end by van der Waals attractive force. Each carbon nanotube segment includes a plurality of carbon nanotubes substantially parallel to each other, and each of the plurality of paralleled carbon nanotubes are in contact with each other and combined by van der Waals attractive force therebetween. Each carbon nanotube segment has a desired length, thickness, uniformity, and shape. There can be clearances between adjacent and juxtaposed carbon nanotubes in the carbon nanotube film 122. Since the carbon nanotube film 122 has a relatively large specific surface area, the carbon nanotube film 122 is adhesive. A thickness of the carbon nanotube film 122 at the thickest location is about 0.5 nanometers to about 100 microns (e.g., in a range from 0.5 nanometers to about 10 microns). The carbon nanotube film 122 can be drawn from a carbon nanotube array.

The term “free-standing” includes, but is not limited to, a carbon nanotube film 122 that does not need to be supported by a substrate. For example, a free-standing carbon nanotube film 122 can sustain the weight of itself when hoisted at one point without significant damage to its structural integrity. If the free-standing carbon nanotube film 122 is placed between two separate supporters, the portion of the free-standing carbon nanotube film 122 suspended between the two supporters maintains structural integrity. The free-standing ability of the carbon nanotube film 122 is realized by the successive carbon nanotubes being joined end to end by van der Waals attractive force.

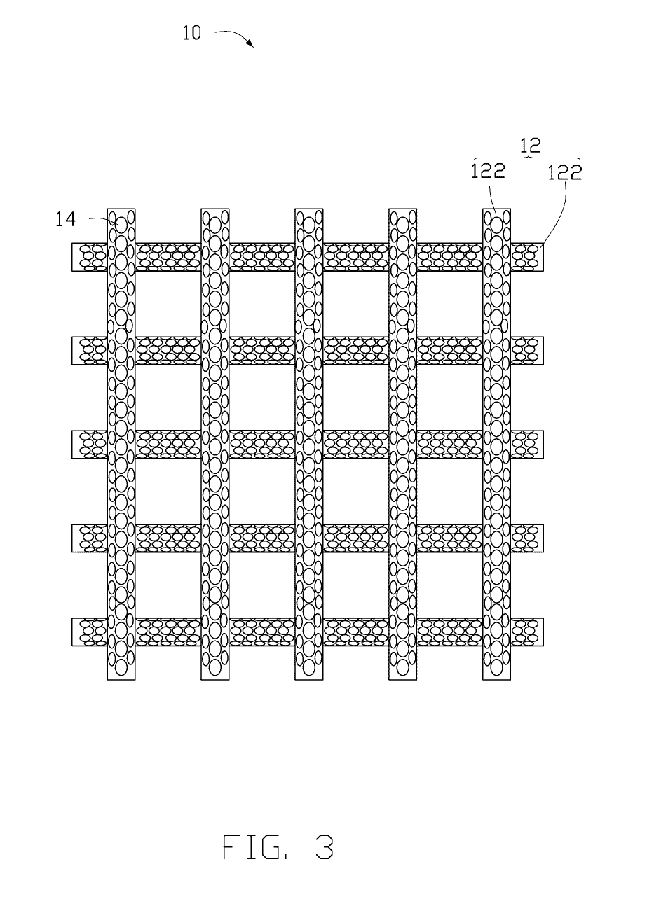

In one embodiment of the cathode 10, the plurality of carbon nanotube films 122 is stacked along same direction as the majority of the carbon nanotubes in the cathode 10. In another embodiment of the cathode 10, the plurality of carbon nanotube films 122 are stacked along at least two directions where the carbon nanotubes in the cathode are substantially aligned along at least two directions. Referring to FIG. 3, when the carbon nanotube films 122 are stacked along two different directions, an angle β is formed between the different directions, and 0°<β≦90°. In one embodiment, the angle β is 90°. In the cathode 10 of the metal-air battery, the number of carbon nanotube films 122 is not limited and can be decided on actual need. In one embodiment, the cathode 10 comprises 10 to 200 layers of carbon nanotube films 122 stacked with each other. In another embodiment, one hundred to two hundred layers of carbon nanotube film 122 are stacked in the cathode 10. The fewer the number of carbon nanotube films 122, the fewer the number of carbon nanotubes to carry the catalyst 14. However, the greater the number of carbon nanotube films 122, the smaller the size of the pores which are defined between adjacent carbon nanotubes. In one embodiment, the effective size of the pores defined between the carbon nanotubes in the carbon nanotube network structure 12 can be in a range from about 10 nanometers to 1 micron (μm). The plurality of the carbon nanotubes in the stacked carbon nanotube films are in direct contact and attached to each other due to the van der Waals force, to form the free-standing carbon nanotube network structure 12. The adjacent carbon nanotubes are connected with each other so the carbon nanotube network structure 12 is electrically conductive. A thickness of the carbon nanotube network structure 12 having about one hundred to about two hundred layers of stacked carbon nanotube films 122 can be in a range from about 4 μm to 10 μm. The carbon nanotube network structure 12 has a relatively uniform thickness and uniform electrical conductivity.

The material of the catalyst 14 can be noble metal such as at least one of ruthenium, platinum, palladium, gold, rhodium, and silver. The catalyst 14 is in particle form, the particles having a size of about 1 nanometer to about 10 nanometers. The particles of the catalyst 14 are uniformly distributed in the carbon nanotube network structure 12 and adsorbed on the outer walls of the carbon nanotubes. A large number of pores defined between adjacent carbon nanotubes having the catalyst 14 adsorbed thereon form a porous cathode 10 which is capable of having the metal ions and oxygen gas infiltrated therein. A weight percentage of the catalyst 14 in the cathode 10 can be in a range from about 50% to about 90%, and from about 75% to about 85% in one embodiment. An amount of the catalyst 14 per unit area of the carbon nanotube network structure 12 can be in a range from 0.5 mg/cm² to 2 mg/cm².

The cathode 10 of the metal-air battery can only comprise the catalyst 14 and the carbon nanotubes. The carbon nanotubes are combined with each other by van der Waals attractive force to form the free-standing carbon nanotube films 122. The carbon nanotube films 122 are not only the carrier of the catalyst 14 but also the current collector of the cathode 10. No additional current collector is required for the cathode 10.

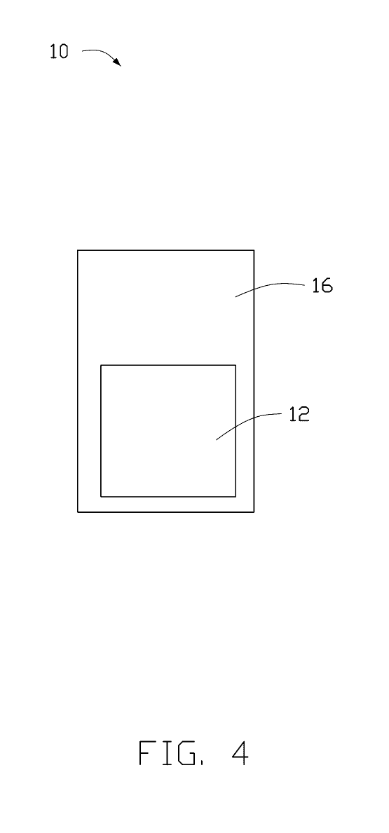

Referring to FIG. 4, in another embodiment, the cathode 10 can further comprise a cathode current collector 16. The carbon nanotube network structure 12 having the catalyst 14 located therein is stacked on a surface of the cathode current collector 16. The cathode current collector 16 electrically connects the carbon nanotube network structure 12 with an external circuit. The cathode current collector 16 can be a porous free-standing sheet. In one embodiment, the cathode current collector 16 can be a metal mesh made of nickel, copper, aluminum, titanium, or stainless steel. In another embodiment, the cathode current collector 16 can be a structure formed of a carbon material such as carbon fiber textile sheet, carbon nanotube paper, porous graphene sheet, carbon nanotube-graphene composite sheet, or pyrolyzed carbon sheet.

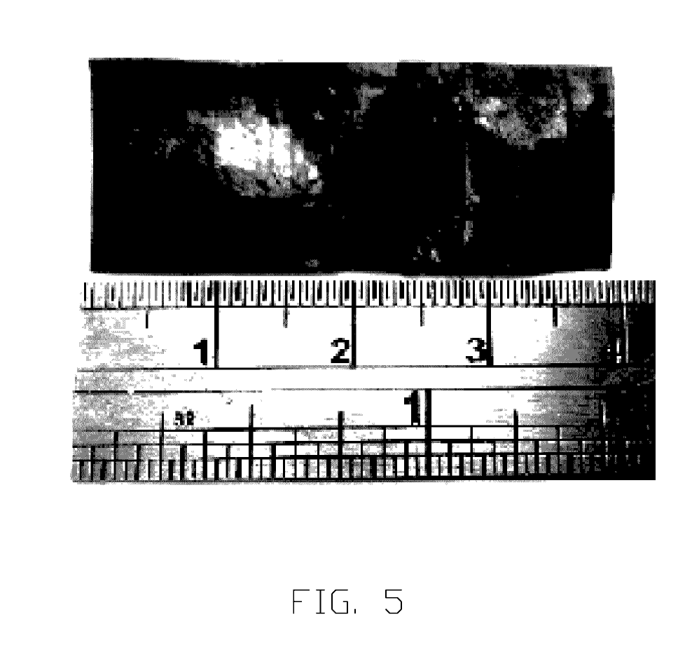

Referring to FIG. 5, in one embodiment, the cathode current collector 16 is carbon nanotube paper which is a black, thin, free-standing sheet that is as flexible as paper and which can be curved or bent. The thickness of the carbon nanotube paper can be in a range from about 500 nm to about 500 μm. The carbon nanotubes paper can consist of about 50 layers to about 1000 layers of the carbon nanotube films 122 stacked with each other. Each carbon nanotube film 122 comprises a plurality of carbon nanotubes arranged along the same direction.

The structure of the carbon nanotube film 122 of the carbon nanotube film paper can be the same as the structure of the carbon nanotube film 122 of the carbon nanotube network structure 12. The carbon nanotube film 122 of the carbon nanotube film paper can be a free-standing carbon nanotube film that is drawn from the carbon nanotube array. The carbon nanotube film 122 has a relatively large specific surface area, so the carbon nanotube film 122 is very adhesive. In the carbon nanotube paper, adjacent carbon nanotube films 122 can be combined together by van der Waals forces. Once the adjacent carbon nanotube films 122 are stacked, the carbon nanotube films 122 can form an integrated structure, and adjacent carbon nanotube films 122 cannot be separated from each other. Spaces can be defined between adjacent carbon nanotubes in the carbon nanotube films 122 to form a plurality of pores in the carbon nanotube paper, allowing oxygen gas to pass through.

In one embodiment, in the carbon nanotube paper, the carbon nanotube films 122 are aligned along the same direction as the in-line majority of the carbon nanotubes. The carbon nanotubes paper has an excellent electrical conductivity in this particular direction. The carbon nanotube paper is used as the cathode current collector 16 in the cathode 10 to collect and conduct the current from the carbon nanotube network structure 12 to the external circuit.

In one embodiment, the direction of the carbon nanotubes of at least one carbon nanotube film 122 in the carbon nanotube network structure 12 is the same as that of the carbon nanotubes in the carbon nanotube paper. At least a portion of the carbon nanotubes in the carbon nanotube network structure 12 are aligned along the same direction as the carbon nanotubes in the cathode current collector 16. Thus, the contact area of the carbon nanotubes increases when the current collector 16 is in contact with the carbon nanotube network structure 12, to enhance the combination therebetween.

The carbon nanotube network structure 12 and the carbon nanotube paper can be in direct contact with each other and combined by van der Waals attractive forces, without additional binder. That is to say, the carbon nanotubes of the carbon nanotube paper are in direct contact with the carbon nanotubes of the carbon nanotube network structure 12. The carbon nanotube films of the carbon nanotube paper and the carbon nanotube network structure 12 have relatively large specific surface areas. Once the carbon nanotube paper and the carbon nanotube network structure 12 are stacked and combined together by van der Waals forces, it will be difficult to separate them from each other. In one embodiment, the carbon nanotube network structure 12 is smaller than the carbon nanotube paper, and can be located on one end of carbon nanotube paper. The other end of the carbon nanotube paper can be used to connect to the external circuit.

In the cathode 10, the catalyst 14 is located not only on an outer surface of the carbon nanotube network structure 12 but is also infiltrated into the carbon nanotube network structure 12, and adsorbed on the outer walls of the carbon nanotubes, to efficiently adopt the carbon nanotubes as the carrier of the catalyst 14. The cathode 10 having the catalyst 14 carried by the carbon nanotube network structure 12 has a plurality of micropores defined by adjacent carbon nanotubes, to permit the passage of oxygen gas and metal ions through micropores of the cathode 10 and make contact with the catalyst 14 in the carbon nanotube network structure 12.

One embodiment of a method for making the cathode 10 of the metal-air battery comprises: providing a plurality of carbon nanotube films 122 drawn from a carbon nanotube array; depositing a plurality of particles made of the catalyst 14 on each of the carbon nanotube film 122 to form a plurality of carbon nanotube-catalyst composite films; stacking the plurality of carbon nanotube-catalyst composite films together to form the cathode 10.

In another embodiment, the cathode 10 comprises the carbon nanotube paper as the current collector. The plurality of carbon nanotube-catalyst composite films is stacked on the carbon nanotube paper to form the cathode 10. The particles of the catalyst can be deposited on the carbon nanotube film 122 by using the chemical depositing method or the physical depositing method, such as the vacuum evaporating method and the magnetron sputtering method. By controlling the depositing time of the catalyst 14, the weight percentage of the catalyst 14 in the cathode 10 can be controlled.

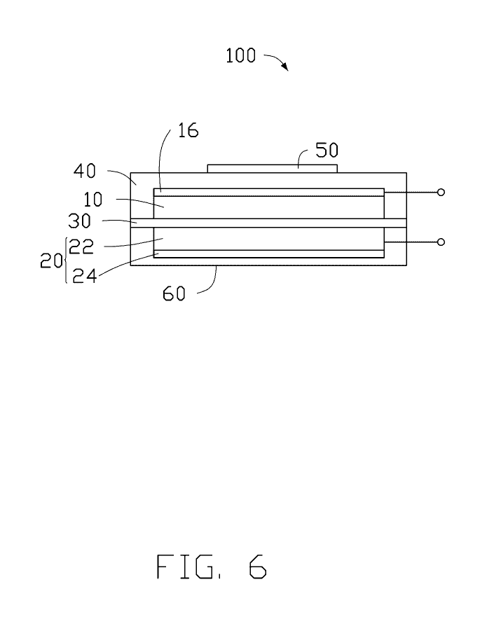

Referring to FIG. 6, one embodiment of a metal-air battery 100 comprises the above described cathode 10, an anode 20, and an electrolyte 30.

The anode 20 comprises an anode active material layer 22, which can be metal or alloy, such as at least one of lithium, sodium, potassium, magnesium, calcium, aluminum, zirconium, iron, silver, and alloys thereof. In one embodiment, the metal-air battery 100 is a lithium-air battery, and the anode active material layer 22 is lithium metal or alloy, such as lithium aluminum alloy, lithium tin alloy, lithium lead alloy, or lithium silicon alloy. The anode 20 can further comprise an anode current collector 24 electrically connecting the anode active material layer 22 to the external circuit. The anode active material layer 22 is located on a surface of the anode current collector 24. The anode current collector 24 can be a free-standing sheet. In one embodiment, the anode current collector 24 can be a metal foil without holes or metal mesh with a plurality of through holes. The metal of the anode current collector 24 can be nickel, copper, or stainless steel. In another embodiment, the anode current collector 24 can be a structure formed of a carbon material such as carbon fiber textile sheet, carbon nanotube paper, porous graphene sheet, carbon nanotube-graphene composite sheet, or pyrolyzed carbon sheet.

The electrolyte 30 is located between the cathode 10 and the anode 20 to conduct metal ions. The electrolyte can be a solid electrolyte film or a liquid electrolyte solution including a metal salt dissolved in an organic solvent. The organic solvent can be at least one of ethylene carbonate (EC), propylene carbonate (PC), ethylmethyl carbonate (EMC), diethyl carbonate (DEC), dimethyl carbonate (DMC), butylenes carbonate, vinylene carbonate, methylethyl carbonate, methyl acetate, ethyl acetate, propyl acetate, methyl propionate, ethyl propionate, y-butyrolactone, 1,2dimethoxyethane, 1,2-diethoxyethane, tetrahydrofuran, 1,2-dioxane, 2-methyltetrahydrofuran, acetonitrile, tetra(ethylene glycol) dimethyl ether (TEGDME), and dimethylformamide. In the embodiment of the metal-air battery 100, the lithium salt can be at least one of LiCl, LiPF₆, LiBF₄, LiCH₃SO₃, LiCF₃SO₃, LiAsF₆, LiSbF₆, LiClO₄, Li[BF₂(C₂O₄)], Li[PF₂(C₂O₄)₂], Li[N(CF₃SO₂)₂], Li[C(CF₃SO₂)₃], LiBOB, and lithium bis(trifluoromethane sulfonyl) imide (LiTFSI). The liquid electrolyte solution infiltrates the cathode 10 and the anode 20.

The metal-air battery 100 can further comprise a porous membrane being a separator 40 located between the cathode 10 and the anode 20. The material of the separator can be polypropylene (PP) or polyethylene (PE).

The metal-air battery 100 can further comprise an air-diffusion membrane 50 arranged on the side adjacent to the cathode 10 of the metal-air battery 100. Oxygen gas can enter the cathode 10 through the air-diffusion membrane 50, and water and carbon dioxide gas in the air can be prevented from entering the cathode 10.

The metal-air battery 100 can further comprise a battery case 60 encapsulating the cathode 10, the anode 20, the electrolyte 30, and the separator 40. The air-diffusion membrane 50 can be located on an opening defined by the battery case 60 at the side adjacent to the cathode 10.

### EXAMPLE 1

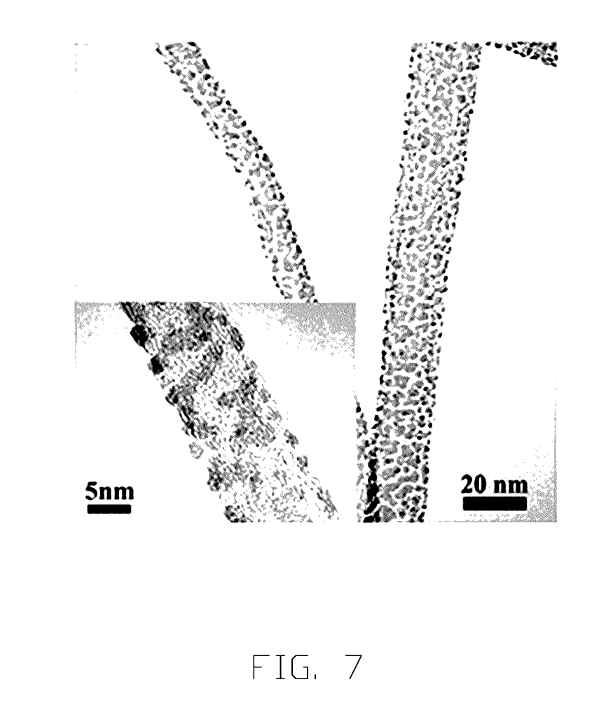

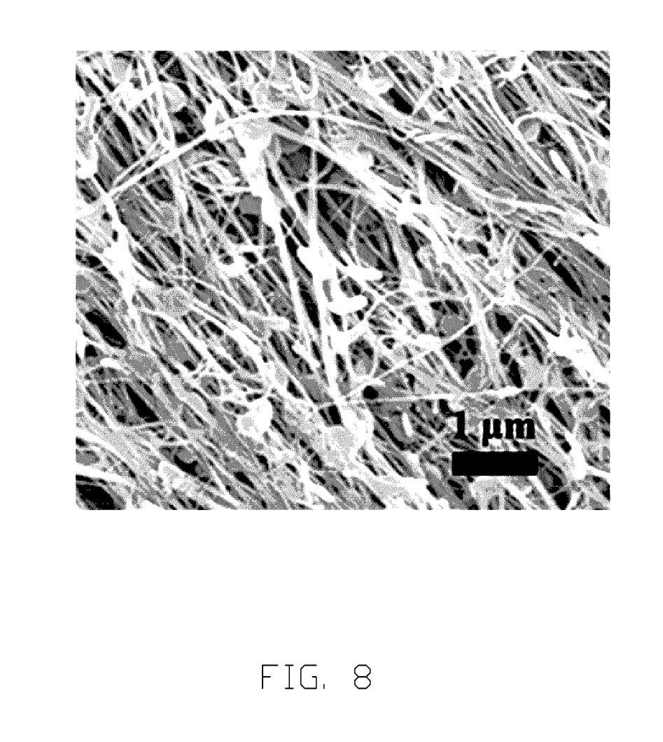

The carbon nanotube films are drawn from the carbon nanotube array and deposited with Ru metal particles through the sputtering method, to form the carbon nanotube-catalyst composite films. Referring to FIG. 7, an average diameter of the Ru metal particles is in a range from about 3 nanometers to about 5 nanometers. The Ru metal particles are uniformly distributed on the outer walls of the carbon nanotubes. The cathode 10 comprises the carbon nanotube paper as the cathode current collector and one hundred layers of carbon nanotube-catalyst composite films are stacked on the surface of the carbon nanotube paper along two directions which are perpendicular to each other. The carbon nanotube paper comprises 500 layers of carbon nanotube films stacked with each other. The thickness of the carbon nanotube paper is about 40 microns. The anode 20 is lithium metal. The electrolyte 30 is 0.1 mol/L of LiTFSI dissolved in TEGDME. After electrical discharge of the metal-air battery 100, the cathode 10 is taken out from the battery case and observed under SEM. Referring to FIG. 8, the solid particles formed on the outer walls of the carbon nanotubes are Li₂O₂ having an average size of about 300 nanometers to about 500 nanometers. Referring to

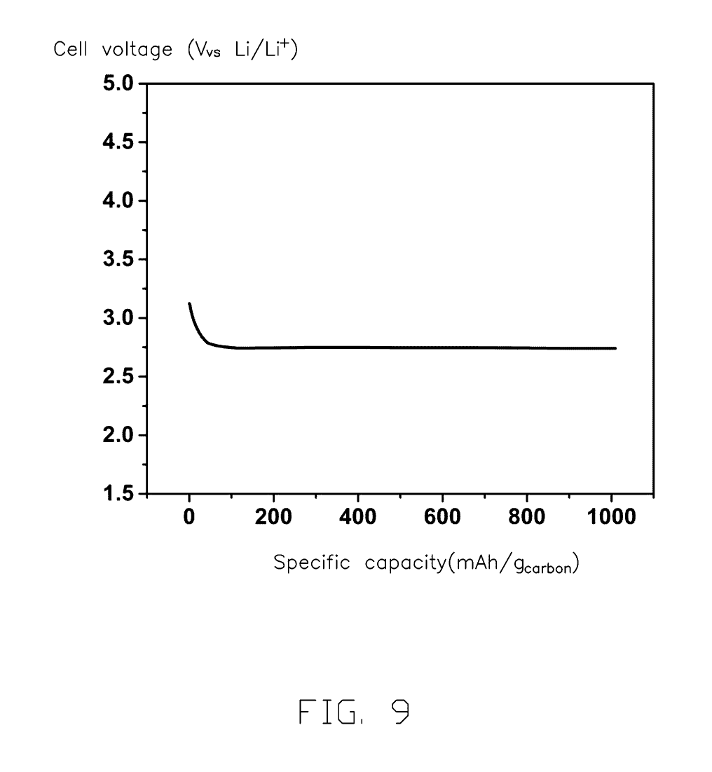

FIG. 9, the metal-air battery 100 is discharged at a current density of about 500 mA/g and cuts off at a specific capacity of about 1000 mAh/g. The discharge voltage plateau is about 2.75V, which is very close to the theoretic value of 2.96V, revealing a relatively high electrode reacting efficiency of the cathode 10 of the metal-air battery 100.

### EXAMPLE 2

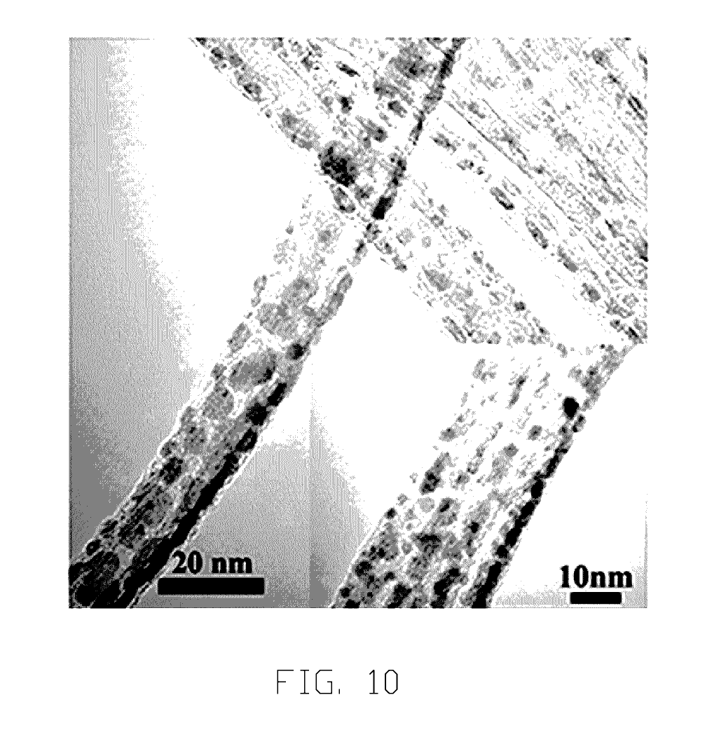

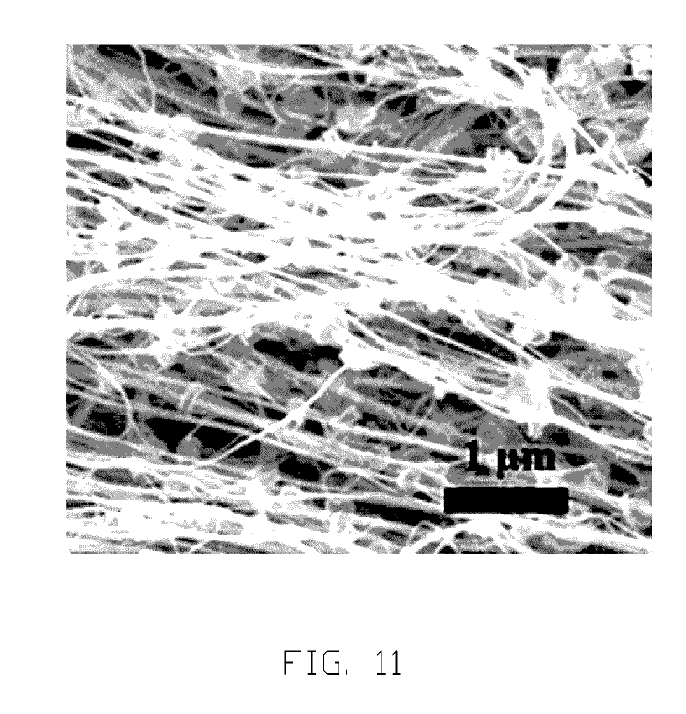

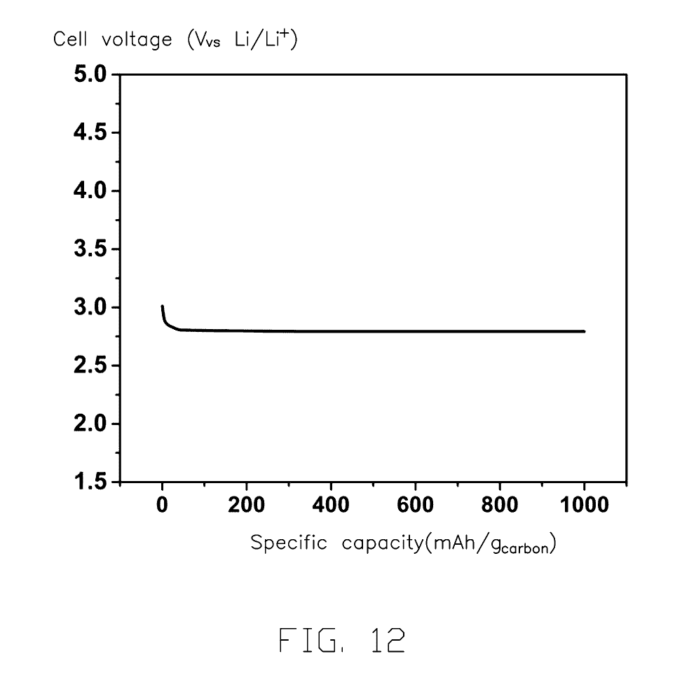

The carbon nanotube films are drawn from the carbon nanotube array and Pd metal particles are deposited thereon through the sputtering method to form the carbon nanotube-catalyst composite films. Referring to FIG. 10, an average diameter of the Pd metal particles is in a range from about 5 nanometers to about 10 nanometers. The Pd metal particles are uniformly distributed on the outer walls of the carbon nanotubes. The cathode 10 comprises the carbon nanotube paper as the cathode current collector. One hundred layers of carbon nanotube-catalyst composite films are stacked on the surface of the carbon nanotube paper along two directions which are perpendicular to each other. The carbon nanotube paper comprises 500 layers of carbon nanotube films stacked with each other. The thickness of the carbon nanotube paper is about 40 microns. The anode 20 is lithium metal. The electrolyte 30 is 0.1 mol/L of LiTFSI dissolved in TEGDME. After electrical discharge of the metal-air battery 100, the cathode 10 is taken out from the battery case and observed under SEM. Referring to FIG. 11, the solid particles formed on the outer walls of the carbon nanotubes are Li₂O₂ having an average size of about 300 nanometers to about 500 nanometers. Referring to FIG. 12, the metal-air battery 100 is discharged at a current density of about 500 mA/g and cuts off at a specific capacity of about 1000 mAh/g. The discharge voltage plateau is about 2.8V, which is very close to the theoretic value of 2.96V, revealing a relatively high electrode reacting efficiency of the cathode 10 of the metal-air battery 100.

Depending on the embodiment, certain of the steps of methods described may be removed, others may be added, and the sequence of steps may be altered. It is also to be understood that the description and the claims drawn to a method may comprise some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A cathode of a metal-air battery, the cathode comprising a carbon nanotube network structure and a catalyst in particle form located in the carbon nanotube network structure, the carbon nanotube network structure comprising a plurality of carbon nanotube films stacked with each other, and each of the plurality of carbon nanotube films comprising a plurality of carbon nanotubes aligned substantially parallel to a surface of the each of the plurality of carbon nanotube films and along a same direction.

2. The cathode of claim 1, wherein a material of the catalyst is selected from the group consisting of ruthenium, platinum, palladium, gold, rhodium, silver, and combinations thereof.

3. The cathode of claim 1, wherein a diameter of the catalyst is in a range from about 1 nanometer to about 10 nanometers.

4. The cathode of claim 1, wherein a weight percentage of the catalyst is in a range from about 50% to about 90%.

5. The cathode of claim 1, wherein an amount of the catalyst per unit area of the carbon nanotube network structure is in a range from 0.5 mg/cm² to 2 mg/cm².

6. The cathode of claim 1, wherein the plurality of carbon nanotubes are joined end to end by van der Waals attractive force therebetween.

7. The cathode of claim 1, wherein an effective pore size defined in the carbon nanotube network structure is in a range from about 10 nanometers to 1 micron.

8. The cathode of claim 1, wherein the plurality of carbon nanotube films equates to 10 to 200 layers of carbon nanotube films staked with each other.

9. The cathode of claim 1, wherein the carbon nanotube network structure is a free-standing structure and a cathode current collector.

10. The cathode of claim 1 further comprising a cathode current collector, wherein the carbon nanotube network structure is located on a surface of the cathode current collector.

11. The cathode of claim 10, wherein the cathode current collector is selected from the group consisting of a metal mesh, a carbon fiber textile sheet, a carbon nanotube paper, a porous graphene sheet, a carbon nanotube-graphene composite sheet, and a pyrolyzed carbon sheet.

12. The cathode of claim 10, wherein the cathode current collector is a carbon nanotube paper comprising another plurality of carbon nanotube films stacked with each other.

13. A metal-air battery comprising:
an anode;
a cathode comprising a carbon nanotube network structure and a catalyst in particle form located in the carbon nanotube network structure, the carbon nanotube network structure comprising a plurality of carbon nanotube films stacked with each other, and each of the plurality of carbon nanotube films comprising a plurality of carbon nanotubes aligned substantially parallel to a surface of the each of the plurality of carbon nanotube films and along a same direction; and
an electrolyte located between the cathode and the anode.

14. The metal-air battery of claim 13, wherein the anode comprises an anode active material layer, a material of the anode active material layer is selected from the group consisting of lithium, sodium, potassium, magnesium, calcium, aluminum, zirconium, iron, silver, and alloys thereof.
